(19) United States
(12) Patent Application Publication
(10) Pub. No.: US 2003/0053898 A1
(43) Pub. Date: Mar. 20, 2003

(54) Collapsible lifting and support cart

(76) Inventor: David B. Wamsley, Indianapolis, IN (US)

Correspondence Address: John V. Moriarty, Woodward, Emhardt, Naughton, Moriarty and McNett, Bank One Center/Tower, 111 Monument Circle, Suite 3700, Indianapolis, IN, 46204-5137, US

(21) Appl. No.: 09/944,661

(22) Filed: Aug. 31, 2001

(51) Int. Cl. B62B 1/00

(52) U.S. Cl. 414/494

(57) ABSTRACT

A collapsible cart for lifting and transporting a race vehicle. A base frame includes a pair of frames pivotally connected together with a platform pivotally mounted thereatop. The platform includes a pair of foldable portions. A winch is operable to pull a race vehicle onto the platform when oriented at an inclined angle with the platform them being pivotable to a horizontal position whereat the race vehicle may be transported.

### BACKGROUND OF THE INVENTION

The present invention relates generally to the field of wagons, carts, and other devices for lifting and moving an item across ground.

### DESCRIPTION OF THE PRIOR ART

A variety of carts are available for transporting items across ground. For example, it is the custom in the racing industry for several persons to physically lift and place go carts, sprint carts and quarter midget race cars onto carts for transportation to another location, such as a truck for long distance transportation. In certain cases, the race vehicle may weigh upwards to 300 lbs. Further, it may be necessary to lift the race vehicle onto a cart to allow access to the underside of the racing vehicle for maintenance.

In view of the above, it is desirable to provide a cart that does not require people to physically lift the racing vehicle onto the cart. A variety of racing vehicle lifts and/or carts are available. For example, Robbins Enterprises distributes a manual and electrically powered cart. The Robbins cart supports and lifts the race vehicle with two separate bars. One of the bars extends across the width of the front of the race vehicle whereas the second bar extends across the width of the aft end of the race vehicle.

Despite the prior carts and lifts, there is a need for a wheeled cart that will both lift and transport the race vehicle and is also collapsible for storage purposes. Further, the cart should allow complete access to the lower side of the race vehicle. Disclosed herein is such a device.

### SUMMARY OF THE INVENTION

One embodiment of the present invention is a collapsible device for lifting and transporting an item across the ground and including a base frame having a first frame and a second frame connected together with the first frame and the second frame each having bottom ends. A plurality of wheels are rotatably mounted to the bottom ends allowing the collapsible device to be moved across the ground. A supporting frame is mounted atop the base frame and has an extended condition to hold the item to be lifted and transported by the collapsible device. The supporting frame is movably mounted to the base frame and movable from a loading position whereat the supporting frame is arranged at an acute angle, for example, a 60 degree angle relative to the ground, to a holding position whereat the supporting frame extends horizontally. A winch is mounted to the collapsible device to pull the item to be lifted onto the supporting frame.

It is an object of the present invention to provide a new and improved lifting and transporting cart.

A further object of the present invention is to provide a lifting and transporting cart for use with race vehicles.

Yet another object of the present invention is to provide a collapsible device for lifting and transporting an item across ground.

Related objects and advantages of the present invention will be apparent from the following description.

### BRIEF DESCRIPTION OF THE DRAWINGS

FIG. 1 is a perspective view of the preferred embodiment of the cart incorporating the present invention in a partially erected condition.

FIG. 2 is a top view of the cart in an extended condition.

FIG. 3 is a perspective view of the cart of FIG. 2 showing a race vehicle being loaded thereon.

FIG. 4 is the same view as FIG. 3 only showing the race vehicle loaded on the cart and in a generally horizontal position.

FIG. 5 is a perspective view of the cart with the aft end of the race vehicle in a lowered position.

FIG. 6 is a perspective view of the cart in a collapsed condition.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

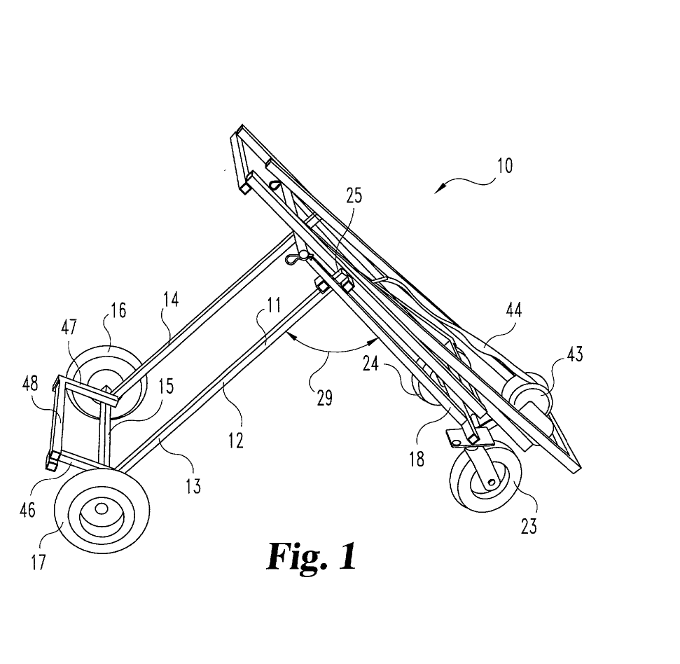

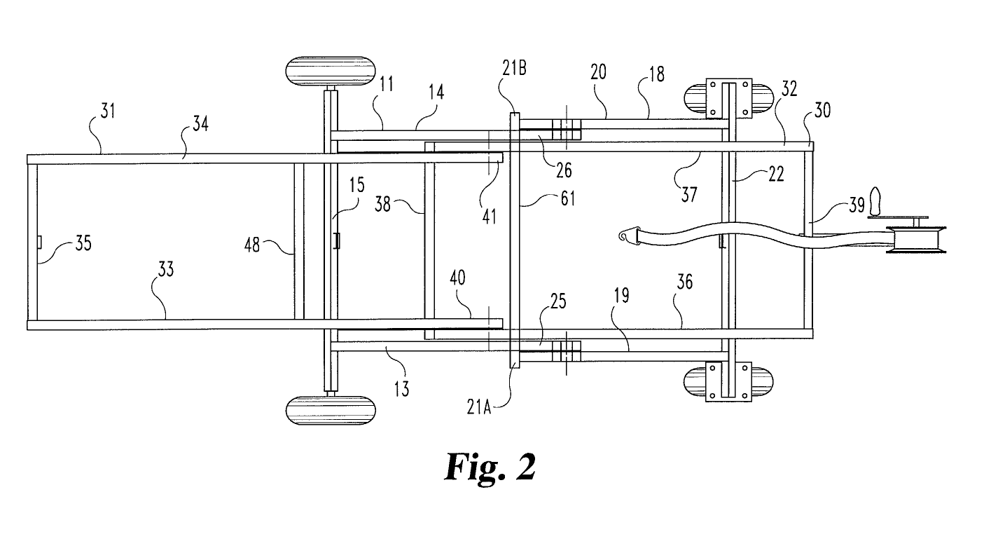

Referring now more particularly to FIG. 1, there is shown a collapsible cart 10 in a partially erected condition. The cart includes a base frame 11 comprising first frame 12 and a second frame 18 pivotally connected together. Frame 12 includes a pair of parallel side rails 13 and 14 fixedly joined to a distal end rail 15 positioned between and perpendicularly arranged between rails 13 and 14. Frame 18 includes a pair of parallel side rails 19 (FIG. 2) and 20 fixedly joined to end rail 22 and a pair of tubes 21A and 21B in a rectangular configuration. A pair of wheels 23 and 24 (FIG. 1) are rotatably mounted to end rail 22 and a pair of wheels 17 and 16 are rotatably mounted to end rail 15. The top ends 25 and 26 (FIG. 2) of rails 13 and 14 are pivotally mounted to rails 19 and 20 of frame 18 at a location beneath the top ends of rails 19 and 20.

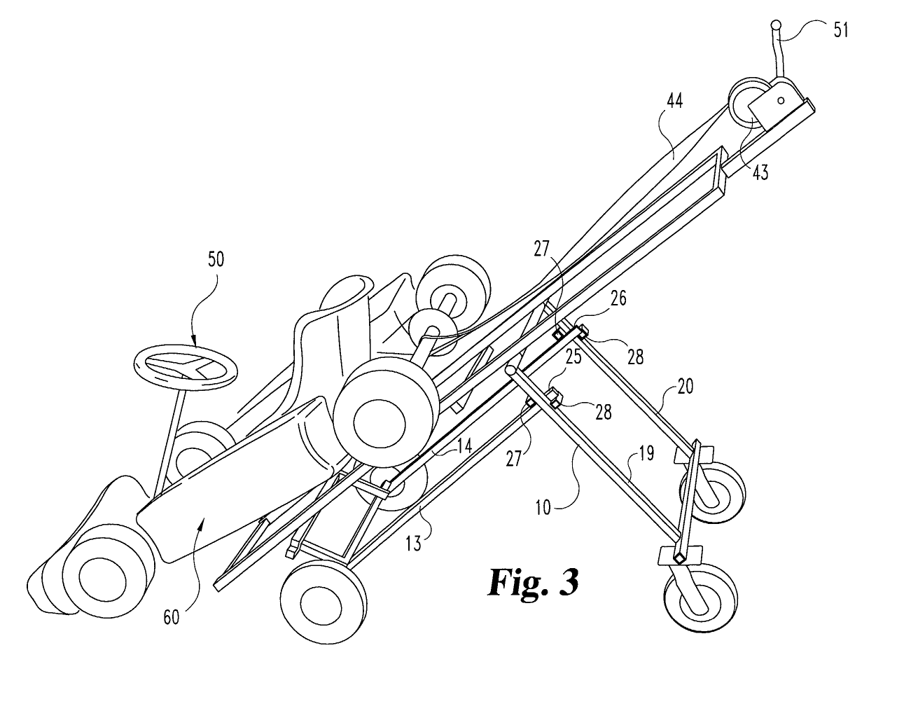

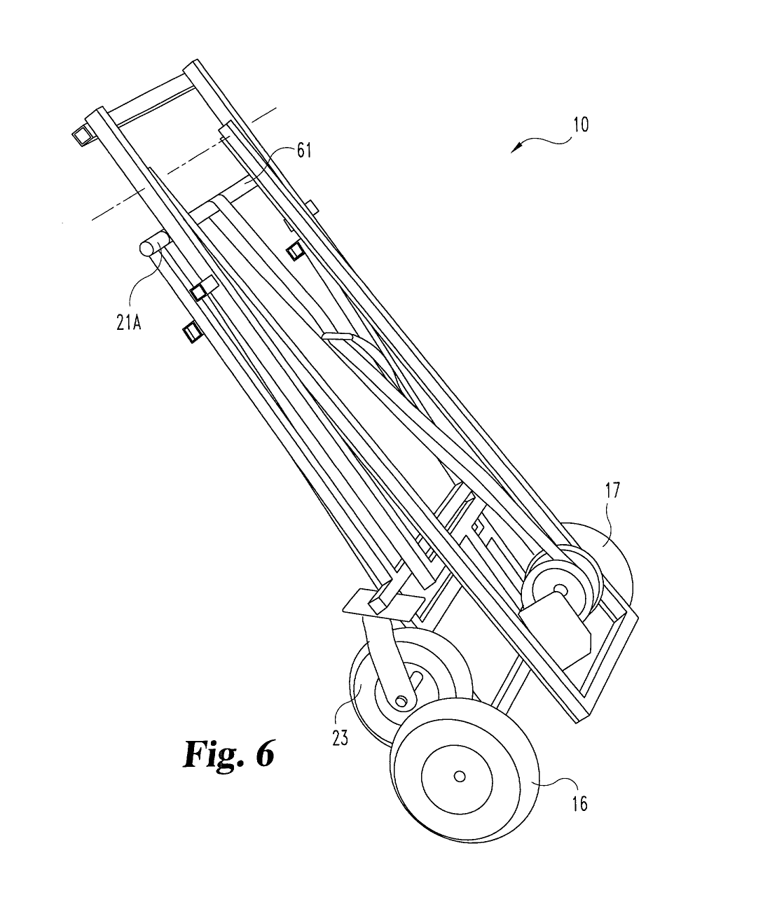

A pair of blocks 27 and 28 (FIG. 3) are fixedly mounted to the opposite sides of the top end 25 of rail 13. Blocks 27 and 28 are spaced apart with rail 19 passing therebetween. As viewed in FIG. 3, block 27 is fixedly mounted to the upwardly facing surface of rail 13 and to the left of rail 19 whereas block 28 is fixedly mounted to the downwardly facing surface of rail 13 and positioned to the right of rail 19. End 25 is pivotally connected to rail 19 by a pivot pin located between block 27 and 28 and below the top end of rail 19. Thus, the included angle 29 (FIG. 1) between rails 13 and 19 is fixed when the cart is in the erected position and wheels 16 and 17 are spaced at their furthest location from wheels 23 and 24. Likewise, frames 11 and 18 may be pivoted together in the collapsed condition depicted in FIG. 6. A similar set of blocks 27 and 28 are provided on the upwardly facing and downwardly facing surfaces of rail 14 with rail 20 extending therebetween.

An upper or supporting frame 30 (FIG. 2) forms a platform pivotally mounted atop base frame 11. The platform or supporting frame 30 includes a pair of foldable frames 31 and 32 pivotally connected together. The foldable frames when extended support the race vehicle by contacting and supporting the race vehicle along its entire length. The foldable frames are collapsible when not supporting the race vehicle as depicted in FIG. 6.

Foldable frame 31 includes a first pair of side rails 33 and 34 fixedly joined together to a distal rail 35 arranged perpendicularly thereto and positioned between rails 33 and 34. Foldable frame 32 also has a pair of parallel side rails 36 and 37 fixedly joined to a pair of end rails 38 and 39 in a rectangular configuration. The proximal ends 40 and 41 of rails 33 and 34 are pivotally mounted to rails 36 and 37 at a location between rails 38 and 39. Rail 38 is in contact with but is positioned beneath rails 36 and 37 thereby providing a support for the downwardly facing surfaces of rails 33 and 34 when in the extended position of FIG. 2.

A pair of spaced apart tubes 21A and 21B are fixedly mounted to the top ends of rails 19 and 18. A third tube 61 is fixedly attached to and beneath rails 36 and 37, has the same inside diameter as tubes 21A and 21B, and is aligned with and located between tubes 21A and 21B. A pivot pin extends thru tubes 21A, 21B and 61 thereby pivotally mounting frame 30 atop base 11. A plurality of plastic covers or sheets are fixedly mounted atop rails 33, 34, 36 and 37 providing a low friction surface upon which the race vehicle may slide without marring the finish of the vehicle.

A winch 43 (FIG. 3) is fixedly mounted to rail 39 and includes a web 44 wrappingly received on the winch spool with the web having a distal end connectable to the race vehicle for pulling the race vehicle 50 onto the platform formed by frame 30 as the handle 51 of the winch is rotated.

A pair of tubular members 46 and 47 are pivotally mounted to rails 13 and 14 (FIG. 1) and are positioned inwardly thereof. The distal ends of members 46 and 47 are fixedly joined to a cross rail 48. Cross rail 48 supports the outer end of foldable frame 31 when frame 31 is in the downwardly extending or inclined position. Rail 48 further keeps rail 35 of foldable frame 31 from contacting the ground. Tubular members 46 and 47 may be pivotally mounted to rails 13 and 14 and pivoted inwardly between rails 13 and 14 when in the collapsed position. A pair of shoulder bolts, not shown, may be mounted to rail 48 with the bolts having top ends extending above rail 48 for contacting rail 35 of foldable frame 31. The shoulder bolts may be adjusted upwardly or downwardly to control the spacing of rail 35 relative to the ground when resting atop the shoulder bolts.

In order to lift and transport a race vehicle with cart 10, frames 11 and 18 are pivoted to maximize the included angle 29 extending therebetween. Next, foldable frame 31 is pivoted in a counterclockwise direction as viewed in FIG. 1 until rails 33 and 34 rest atop end rail 38. The upper or supporting frame 30 is then pivoted clockwise as a unit until the frame extends downwardly in an inclined or loading position as depicted in FIG. 3. Thus, frame 30 is arranged at an acute angle, for example, a 60-degree angle, relative to the ground. The distal end of web 44 is attached to one end of the race vehicle 50 with the winch crank 51 then being rotated slowly pulling the vehicle 50 upwardly. Rails 33 and 34 and rails 36 and 37 extend along the entire length of the race vehicle contacting the underside of the vehicle as the vehicle is pulled upwardly.

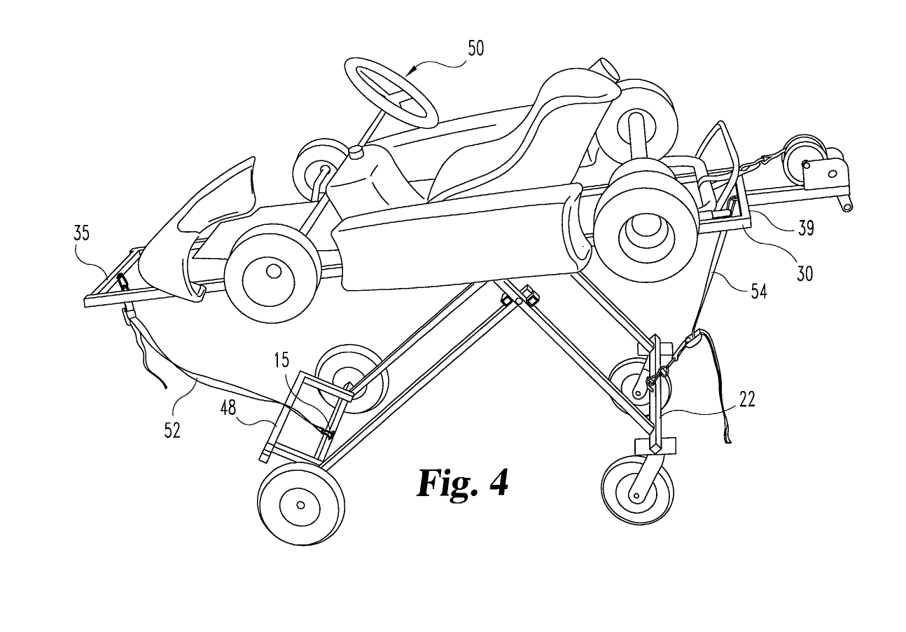

When vehicle 50 is at its maximum elevation and closest to the winch, frame 30 is pivoted in a clockwise direction, as viewed in FIG. 3, until frame 30 and race vehicle 50 extend horizontally as depicted in FIG. 4. Web 54 is attached between rails 39 and 22 whereas web 52 is attached between rails 35 and 15. Webs 54 and 52 are tightened thereby holding frame 30 and race vehicle 50 in the horizontal position allowing the combination of the cart and race vehicle to be moved across the ground.

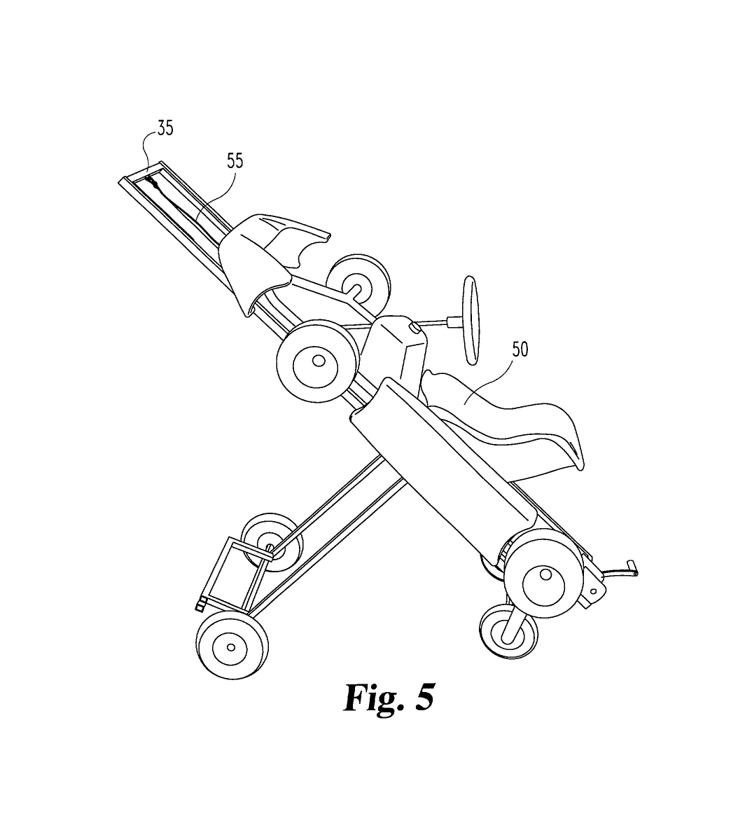

When in the horizontal or inclined positioned, complete access is provided to the underside of the race vehicle since the supporting rails of frame 30 are spaced apart. Thus, work can be performed on the race vehicle when the vehicle is in the loading position of FIG. 3 or the horizontal or stored position of FIG. 4. Likewise, web 52 may be disconnected allowing the platform 30 and race vehicle 50 to pivot further in a clockwise direction as depicted in FIG. 5 allowing further access to the underside of the race vehicle. In the inclined position of FIG. 5, a web 55 may be connected between the end of the race vehicle and rail 35 to secure the race vehicle.

Race vehicle 50 may be loaded onto another vehicle, such as, a truck, by simply pushing race vehicle 50 onto the truck from the elevated and horizontal position of FIG. 4. Alternatively, frame 30 may be pivoted to the inclined position of FIG. 3 with winch 43 then being operated to slowly lower the race vehicle onto the ground.

Once race vehicle 50 is removed from the cart, the cart may be collapsed by pivoting foldable frame 31 in a clockwise direction as viewed in FIG. 4 until frame 31 rests atop frame 32 as depicted in FIG. 1. Frame 12 may then be pivoted in a counterclockwise direction as viewed in FIG. 1 until adjacent frame 18 to the completely collapsed position as depicted in FIG. 6. Wheels 23 and 24 include casters so that the wheels are both rotatably and pivotally mounted to the cart. Wheel 16 and 17 do not include castors and are spaced further apart than wheels 23 and 24 in order to allow frame 12 to pivot adjacent frame 18. Further, wheels 23 and 24 are spaced apart from the pivot connection between frames 12 and 18 a distance less than wheels 16 and 17 from the pivot connection to allow the cart when collapsed to move on wheels 16 and 17 rather than on wheels 23 and 24. Wheels 16 and 17 are of larger diameter than wheels 23 and 24.

The cart disclosed herein is particularly advantageous in that the cart picks up and lowers any go-cart or quarter midget up to 300 lbs. In the preferred embodiment, the cart disclosed herein lifts the race vehicle to a convenient 30-inch working height. The cart rolls easily on rough terrain utilizing 10-inch pneumatic tires plus 8-inch pneumatic casters. The rails of the upper platform of the cart provide a friction free slide surface allowing the race vehicle chassis or frame 60 to be easily moved therefrom. One person can easily load the race vehicle from the cart into and out of a pick-up truck. The upper frame of the cart can be oriented to position either the chassis nose up or down to allow work on the underside of the vehicle. Further, the combination of the race vehicle and cart allows easy maintenance of the race vehicle without requiring manpower to physically lift the vehicle onto a cart or other working surface.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A collapsible device for lifting and transporting an item across ground comprising:
a base frame having a first frame and a second frame connected together with said first frame and said second frame each having bottom ends;
a plurality of wheels rotatably mounted to said bottom ends of said first frame and said second frame for allowing the collapsible device to be moved across ground;
a supporting frame mounted atop said base frame and having an extended condition to hold the item to be lifted and transported by the collapsible device, said supporting frame movably mounted to said base frame and movable from a loading position whereat said supporting frame is arranged at an acute angle relative to ground to a holding position whereat said supporting frame extends horizontally; and,
a winch mounted to the collapsible device to pull the item to be lifted onto said supporting frame.

2. The collapsible device of claim 1 wherein:
said supporting frame is pivotally mounted to said base frame and includes a first portion and a second portion collapsibly connected together allowing said supporting frame to be collapsed from said extended condition.

3. The collapsible device of claim 2 wherein:
said first portion has a first end with said winch mounted thereon, said first portion further has a second end with a cross support, said second portion when in said extended position rests atop said cross support and is pivotally mounted between said cross support and said first end of said first portion.

4. The collapsible device of claim 3 wherein:
said first portion includes a pivot member fixedly mounted thereto between said first end and said cross support with said pivot member connected to said base frame.

5. The collapsible device of claim 2 wherein:
said supporting frame has opposite ends and includes a pivot connection located between said opposite ends;
said first frame has a top end pivotally connected to said pivot connection allowing said first frame to be pivoted upwardly adjacent said supporting frame when collapsed, said first frame has a second pivot connection and said second frame has an upper end pivotally connected at said second pivot connection to said first frame below said top end allowing said second frame to be pivoted adjacent said first frame when collapsed.

6. The collapsible device of claim 5 wherein:
said upper end of said second frame includes a pair of stops mounted thereon to limit the included angle between said first frame and said second frame when erected but allowing said second frame to be pivoted adjacent said first frame when collapsed; and further comprising:
a strap connectable between said first end of said first portion and said first frame of said base frame to limit movement between said base frame and said supporting frame when erected.

7. The collapsible device of claim 5 wherein:
said first portion has a first end with said winch mounted thereon, said first portion further has a second end with a cross support, said second portion when in said extended position rests atop said cross support and is pivotally mounted between said cross support and said first end of said first portion, said first portion includes a pivot member fixedly mounted thereto between said first end and said cross support with said pivot member connected to said base frame;
said wheels are both rotatably and pivotally mounted to said base frame.

8. The collapsible device of claim 5 wherein:
said wheels on said first frame are spaced apart from said second pivot connection a distance less than said wheels on said second frame from said second pivot connection allowing the collapsible device when collapsed to be moved over ground upon the wheels mounted on said second frame rather than on said wheels on said first frame; and
said supporting frame when in said loading position is arranged at a 60 degree angle relative to the ground.

9. A collapsible device for lifting a race vehicle off of the ground comprising:
a base frame;
a plurality of wheels mounted to said frame to movably support said frame on the ground;
a horizontal platform for holding a race vehicle above ground in a horizontal position, said platform movably mounted atop said base frame and with said platform movable on said base frame from a horizontal position to an inclined position and vice-versa; and,
a pulling device to pull a race vehicle onto said platform when in said inclined position whereupon said platform is then moved from said inclined position to said horizontal position.

10. The collapsible device of claim 9 wherein:
said base frame includes a first frame and a second frame pivotally connected together allowing said first frame and said second frame to be collapsed together;
said horizontal platform includes a first portion and a second portion pivotally connected together allowing said first portion and said second portion to be collapsed together; and,
said base frame and said platform are pivotally connected together allowing said base frame and said platform to be collapsed together.

11. The collapsible device of claim 10 wherein:
said first portion of said horizontal platform includes a first pair of side rails and a pair of end rails fixedly joined together in a rectangular configuration, said second portion of said horizontal platform includes a second pair of side rails and a distal rail perpendicularly joined to and positioned between said second pair of side rails, said first pair of rails and said second pair of rails are pivotally connected together with said pulling device mounted to one of said first pair of end rails with the remaining one of said first pair of end rails located beneath said first pair of side rails and supporting said second pair of rails when said second pair of rails extend horizontally with said first pair of rails.

12. The collapsible device of claim 11 wherein:
said first frame includes a first pair of tubular members pivotally connected to said first pair of rails, said second frame includes a second pair of tubular members pivotally connected to said first pair of tubular members, said second pair of tubular members include a pair of stop surfaces limiting pivotal motion between said first frame and said second frame when in an erected condition.

13. A combination race vehicle and cart comprising:
a race vehicle having a frame and vehicle wheels rotatably mounted thereto; and,
a collapsible cart for holding said race vehicle, said collapsible cart including:
a collapsible base frame with cartwheels rotatably mounted thereto,
a platform movably mounted to said base frame and having a horizontally extending position and a loading position with said platform arranged at an acute angle relative to ground when in said loading position, said platform including spaced apart side rails, and,
a winch mounted to said platform for connecting to said race vehicle and pulling said race vehicle onto said side rails of said platform when said side rails are in said loading position, said winch holding said race vehicle on said side rails as said platform is moved from said loading position to said horizontally extending position.

14. The combination race vehicle and cart of claim 13 wherein:
said platform includes a pair of foldable frames connected together, said foldable frames when extended and supporting said race vehicle contact and support said race vehicle along its length with said foldable frames being collapsible when not supporting said race vehicle.

15. The combination race vehicle and cart of claim 14 wherein:
said base frame include a pair of tubular frames pivotally connected together with one of said tubular frames pivotally connected to said platform.

16. The collapsible device of claim 15 wherein:
said pair of foldable frames include a first pair of side rails and a pair of end rails fixedly joined together in a rectangular configuration and a second pair of side rails and a distal rail perpendicularly joined to and positioned between said second pair of side rails, said first pair of rails and said second pair of rails are pivotally connected together with said winch mounted to one of said first pair of end rails with the remaining one of said first pair of end rails located beneath said first pair of side rails and supporting said second pair of rails when said second pair of rails extend horizontally with said first pair of rails.

17. The collapsible device of claim 16 wherein:
said pair of tubular frames include a first pair of tubular members pivotally connected to said first pair of rails and a second pair of tubular members pivotally connected to said first pair of tubular members, said second pair of tubular members include a pair of stop surfaces limiting pivotal motion between said pair of tubular frames when in an erected condition.
